(19) United States
(12) Patent Application Publication
(10) Pub. No.: US 2002/0071087 A1
(43) Pub. Date: Jun. 13, 2002

(54) Liquid crystal display device and method thereof

(75) Inventors: Hiroshi Suzuki, Yamato-shi (JP); Shigetaka Kobayashi, Hyogo-ken (JP); Midori Suzuki, Yokohama-shi (JP); Taroh Hasumi, Tokyo (JP)

Correspondence Address: IBM CORPORATION, T.J. WATSON RESEARCH CENTER, P.O. BOX 218, YORKTOWN HEIGHTS, NY, 10598, US

(73) Assignee: IBM

(21) Appl. No.: 09/683,092

(22) Filed: Nov. 16, 2001

(30) Foreign Application Priority Data
Nov. 17, 2000 (JP) 2000-351792

(51) Int. Cl. G02F 1/1339

(52) U.S. Cl. 349/155

(57) ABSTRACT

A dam is formed between drawing wires adjacent to each other. This dam is formed in the same step of forming a polymer layer having a displaying electrode thereon in the polymer film on an array(PFA)-type liquid crystal display device.

### BACKGROUND OF INVENTION

The present invention relates to a liquid crystal display device, more particularly, to a method of connecting drawing wires or pad wiring to array on a glass substrate, which constitutes the liquid crystal display panel, to a printed circuit board via a tape automated bonding (TAB) tape carrier package.

A liquid crystal display device has been remarkably widespread as an image display device for a personal computer or of other various types of monitors. The liquid crystal display device of this type typically constitutes a backlight as a plane-shaped light source for illumination is disposed on a back surface of the liquid crystal display panel. A liquid crystal plane having a specified area is illuminated to have even brightness as a whole, and thus an image formed on the liquid crystal plane is visualized.

The liquid crystal display device comprises: a liquid crystal display panel made from two glass substrates with a liquid crystal material being sealed therebetween. A printed circuit board for driving the liquid crystal material is mounted on the liquid crystal display panel. A backlight unit is disposed on the back surface of the liquid crystal display panel with a liquid crystal display panel holding frame being interposed therebetween. An outer frame surrounds the above-described components.

Among such liquid crystal display devices, in the case of a thin film transistor (TFT) liquid crystal display device, with respect to the two glass substrates making up the liquid crystal display panel, one glass substrate comprises an array substrate, and the other glass substrate comprises a color filter substrate. On the array substrate, drawing wires for electrically connecting the array substrate to the printed circuit board are formed, as well as TFTs as driving elements of the liquid crystal material, displaying electrodes and signal lines. Moreover, the TFTs are regularly arrayed on the glass substrate, thus referred to as the array substrate. On the color filter substrate, common electrodes, a black matrix and the like are formed besides color filters.

The printed circuit board is connected to the electrodes formed on the array substrate via a TAB tape carrier package. FIG. 8 is a plan view showing an arrangement where a printed circuit board 100 and an array substrate 110 are connected to each other via a TAB tape carrier package 120.

The TAB tape carrier package 120 includes: an insulating film tape 121; input lead conductors 122 provided on the first surface of the insulating film tape 121; and output lead conductors 123 provided on the second surface thereof. Moreover, the TAB tape carrier package 120 includes a chip attachment aperture 124 giving an attaching position of a liquid crystal driver chip 126. The input lead conductors 122 extend from the chip attachment aperture 124 toward one edge of the TAB tape carrier package 120. And, the input lead conductors 122 are terminated across a slender slot 125 formed along this one edge. The output lead conductors 123 extend from the chip attachment aperture 124 toward the other end of the TAB tape carrier package 120. The liquid crystal driver chip 126 is connected to the input lead conductors 122 and the output lead conductors 123 at the position of the chip attachment aperture 124.

The input lead conductors 122 of the TAB tape carrier package 120 are connected to corresponding conductors (not shown) of the printed circuit board 100 with solder, for example. Meanwhile, the output lead conductors 123 of the TAB tape carrier package 120 are connected to corresponding drawing wires on the array substrate 110.

An anisotropic conductive film (ACF) has been used for connecting the output lead conductors 123 of the TAB tape carrier package 120 to the corresponding drawing wires on the array substrate 10. The ACF is a film having conductive particles dispersed in a connecting member and having a thickness of 15 to 30 micrometers. A connecting method of the output lead conductors 123 of the TAB tape carrier package 120 to the corresponding electrodes of the array substrate 110 by the use of the ACF will be explained thereinafter, with reference to FIGS. 9 and 10.

FIGS. 9 and 10 schematically show a cross-section of FIG. 8 taken along a portion A-A. FIG. 9 shows a situation before the TAB tape carrier package 120 and the array substrate 110 are connected to each other, and FIG. 10 shows a situation after they are connected. In FIG. 9, the TAB tape carrier package 120 and the array substrate 110 face each other, and the output lead conductors 123 formed on a lower surface of the insulating film tape 121 and the drawing wires 111 formed on the array substrate 110 face each other. In this situation, the TAB tape carrier package 120 and the array substrate 110 are spaced apart with a specified gap to each other, and an ACF 130 is disposed therebetween. The ACF 130 as a connecting member typically has conductive particles 131 dispersed in thermosetting resin 132. In a state where the output lead conductors 123 and the drawing wires 111 are aligned to each other, the TAB tape carrier package 120 and the array substrate 110 are compressed to be bonded to each other, and at the same time, the ACF 130 is heated. Then, the thermosetting resin 132 is softened, and then cured. As described above, the thermosetting resin 132 is softened and fluidized, and thus, as shown in FIG. 10, while the thermosetting resin 132 fills the gap between the TAB tape carrier package 120 and the array substrate 110, the conductive particles 131 remaining between the output lead conductors 123 and the drawing wires 111 realize electrical connection between the output lead conductors 123 and the drawing wires 111. This electrical connection brings about electrical connection between the array substrate 110 and the printed circuit board 100.

Resolution of the liquid crystal display device has been-enhanced progressively, and in accordance with the enhancement of the resolution, a mutual pitch between the drawing wires 111(and also output lead conductors 123) has been narrowed. This narrowed pitch causes the following two technical subjects to the connection between the TAB tape carrier package 120 and the array substrate 110, which is performed by the use of the ACF 130.

The first technical subject is mis-positioning of the output lead conductors 123 to the drawing wires 111 due to thermal expansion of the TAB tape carrier package 120. When the TAB tape carrier package 120 and the array substrate 110 are connected to each other by the use of the ACF 130, the ACF 130 is heated. However, since only the ACF 130 cannot be locally heated, a periphery thereof is also heated simultaneously. In this case, the insulating film tape 121 constituting the TAB tape carrier package 120 is thermally expanded to a larger extent as compared with the array substrate 110. Accordingly, even if the drawing wires 111 and the output lead conductors 123 are aligned to each other before a heating step, mis-positioning between the drawing wires 111 and the output lead conductors 123 occurs after the heating step is performed therefore as shown in FIG. 10. In an extreme case, positions of the drawing wires 111 and the output lead conductors 123, which correspond to each other, are completely misaligned, thus the reliability of the electrical connection cannot be secured. Therefore, it has been examined to dispose the output lead conductors 123, estimating a thermal expansion coefficient of the insulating film tape 121. However, under the situation where the resolution of the liquid crystal display device is further enhanced, the countermeasure examined as described above has reached the limit.

The second technical subject is that, in a process of connecting the TAB tape carrier package 120 and the array substrate 110 to each other, more specifically, in a thermo-compression bonding process of the ACF 130, the number of conductive particles 131 flowing out with the thermosetting resin from a space between the drawing wires 111 and the output lead conductors 123 is increased. In such a case, it becomes difficult to sufficiently secure the reliability of the electrical connection between the drawing wires 111 and the output lead conductors 123.

A method capable of solving the above-described two technical subjects is disclosed in the gazettes of Japanese Patent Laid-Open Nos. Hei 4(1992)-132640 and Hei 11(1999)-186684. Specifically, in this method, protrusions 142 made of an insulative substance are formed between drawing wires 141 on a glass substrate 140 as shown in FIGS. 11(a) and 11(b). Thus, even if the insulating film tape 121 constituting the TAB tape carrier package 120 is expanded by heating, motion of the output lead conductors 123 is restricted by the protrusions 142. Accordingly, there is no concern about the mis-positioning between the drawing wires 141 and the output lead conductors 123 after the heating step is performed therefore. Moreover, the flowing out of the conductive particles 131 in the ACF 130 from the space between the drawing wires 141 and the output lead conductors 123 can be prevented. Accordingly, the reliability of the electrical connection can be secured.

However, it has not been taught yet that the method proposed in the gazettes of Japanese Patent Laid-Open Nos. Hei 4(1992)-132640 and Hei 11(1999)-186684 is actually adopted for the liquid crystal display device. One factor for not adopting the method is that the method is not desirable from a viewpoint of a manufacturing cost of the liquid crystal display device, which is as important as higher resolution, since a new step must be added to the conventional manufacturing process of the liquid crystal display device in order to form the protrusions 142.

### SUMMARY OF INVENTION

Accordingly, the object of the present invention is to provide a technique capable of securing the reliability of the electrical connection for the high-resolution liquid crystal display device without any additional step.

Specifically, a feature of the present invention provides a liquid crystal display panel having an array substrate having a driving element for a liquid crystal material formed thereon, a color filter substrate disposed facing to the array substrate with a specified gap therebetween, and a liquid crystal layer located in the gap between the array substrate and the color filter substrate. The array substrate includes an insulating substrate having an image displaying area and a non-image displaying area, the driving element for the liquid crystal material formed on the image displaying area on the insulating substrate, a polymer layer for covering the image displaying area including the driving element, a displaying electrode formed on the polymer layer and connected with the driving element electrically through the polymer layer, a plurality of drawing wires formed on the non-image displaying area of the insulating substrate for connecting to an exterior electrically, and a protrusion provided between the drawing wires adjacent to each other and made of resin of the same material as that of the polymer layer.

Another feature of the present invention provides a method for manufacturing a liquid crystal display panel. The method includes the steps of: (a) forming a driving element for a liquid crystal material and a plurality of drawing wires for electrically connecting to an exterior on an insulating substrate; (b) forming a polymer layer on the insulating substrate including the driving element and the drawing wires; (c) forming a through hole reaching the driving element in the polymer layer and removing the polymer layer existing on the drawing wires; and (d) forming a displaying electrode penetrating the through hole formed in the step (c) to be electrically connected to the driving element.

According to yet another feature of the present invention, provided is a liquid crystal display device in which a displaying electrode formed on an insulating layer and an array substrate including a plurality of drawing wires for electrically connecting to an exterior is provided, the liquid crystal display device comprising: a liquid crystal display panel including, an array substrate having a protrusion made of the same material as that of the insulating layer provided between the drawing wires adjacent to each other, a color filter substrate disposed facing to the array substrate, and a liquid crystal layer disposed between the array substrate and the color filter substrate, the liquid crystal layer consisting of a liquid crystal material; a circuit board for supplying a driving voltage to the liquid crystal material; and a sheet member for electrically connecting the circuit board and the liquid crystal display panel to each other, the sheet member having output conductors corresponding to the drawing wires.

Moreover, another feature of the present invention provides a liquid crystal display device having a liquid crystal display panel including a displaying electrode for applying a voltage to a liquid crystal material and a glass substrate having a plurality of drawing wires formed thereon for electrically connecting between the displaying electrode and an exterior, a circuit board for supplying the voltage to the liquid crystal material, and a sheet member for electrically connecting the glass substrate and the circuit board to each other. The sheet member is connected to the glass substrate with a connecting member. The glass substrate of the liquid crystal display panel has the displaying electrode provided on a polymer layer formed in an image displaying area of the liquid crystal display panel. Also, a dam being made of the same material as that of the polymer layer is placed between the drawing wires adjacent to each other outside of the image displaying area.

The above-described liquid crystal display device of the present invention can be obtained by the following method. Specifically, the method of manufacturing a liquid crystal display device of the present invention is a method of manufacturing a liquid crystal display device, in which a liquid crystal display panel and a circuit board for driving the liquid crystal display panel are connected to each other via a tape carrier package, the liquid crystal display panel including a first insulating layer forming a displaying electrode on the surface thereof and a plurality of drawing wires performing electrical connection to an exterior, the method comprising the steps of: forming the first insulating layer and forming a second insulating layer between the drawing wires adjacent to each other in a process of obtaining the liquid crystal display panel; and connecting the tape carrier package and the liquid crystal display panel via a connecting member.

The present invention can be summarized as a connected body of substrates comprising: a first substrate including a plurality of first wires formed with a specified space therebetween, a first polymer layer formed between the first wires adjacent to each other, the first polymer layer having a thickness larger than the first wire, and a second polymer layer covering an area different from an area having the first wire and the first polymer layer formed thereon, the second polymer layer being formed of the same material as that of the first polymer layer; a second substrate including a plurality of second wires electrically connected to the first wires; and a connecting member layer mechanically connecting the first substrate and the second substrate.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

For a more complete understanding of the present invention and the advantages thereof, reference is now made to the following description taken in conjunction with the accompanying drawings.

FIG. 1 is a perspective view showing a liquid crystal display panel according to the embodiment of the subject invention.

FIG. 2 is a cross-sectional view showing a liquid crystal display device according to the embodiment of the subject invention.

FIGS. 3(a) to 3(c) are views showing a manufacturing process of an array substrate according to the embodiment of the subject invention.

FIGS. 4(a) to 4(c) are views showing the manufacturing process of the array substrate according to the embodiment of the subject invention.

FIG. 5 is a perspective view showing a peripheral area of the array substrate according to the embodiment of the subject invention.

FIG. 6 is a view showing a step according to this embodiment, of connecting the array substrate and a TAB tape carrier package by the use of an ACF.

FIG. 7 is a view showing a step according to this embodiment, of connecting the array substrate and the TAB tape carrier package by the use of the ACF.

FIG. 8 is a plan view showing a connection of the array substrate and a printed circuit board by the TAB tape carrier package.

FIG. 9 is a view showing a conventional step of connecting the array substrate and the TAB tape carrier package to each other by the use of the ACF.

FIG. 10 is a view showing a conventional step of connecting the array substrate and the TAB tape carrier package to each other by the use of the ACF.

FIGS. 11(a) and 11(b) are views showing the conventional step of connecting the array substrate and the TAB tape carrier package to each other by the use of the ACF.

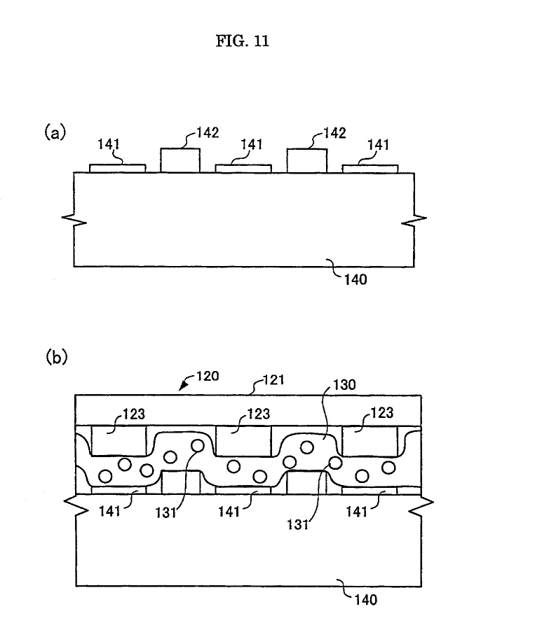

### DETAILED DESCRIPTION

Recently, a liquid crystal display panel (device) referred to as a “polymer film on array (PFA)” type has been developed. The PFA is a technique developed for the purpose of improving an aperture ratio. In the conventional TFT liquid crystal display device, a gap between displaying electrodes and signal lines in a horizontal direction must be secured to have a specified value or wider in order to prevent a short circuit therebetween. Since this gap becomes a portion where light irradiated from the light source of the liquid crystal display device leaks, a black matrix must cover this gap.

The improvement of the aperture ratio has been inhibited by the area covered with the black matrix in the conventional liquid crystal display device. Meanwhile, in the PFA-type liquid crystal display panel, a polymer layer as an insulating layer is formed, and the displaying electrodes are formed thereon. Thus, the gap between the displaying electrodes and the signal lines in the horizontal direction does not need to be secured.

Here, the PFA-type liquid crystal display device forms the polymer layer as the insulating layer. This polymer layer is required for an image displaying area of the liquid crystal display panel. Accordingly, though the polymer layer is once formed on a non-image displaying area, it has been removed afterward. The present invention was aimed at a method that a part of the polymer layer formed on the non-image displaying area, which has been heretofore removed, specifically, the polymer between the above-described drawing wires, is made to remain and function as the above-described protrusions. In this case, a step of providing a polymer layer for forming the protrusions does not need to be newly provided. And according to the method as described above, the protrusions made of the polymer of the same material as that of the polymer layer formed for the other purpose can be formed.

According to the liquid crystal display panel of the present invention, since the displaying electrode is provided on the polymer layer formed on the insulating substrate, a problem of a short circuit between the displaying electrode and the signal line is solved. Moreover, according to the liquid crystal display panel of the present invention, since the protrusion provided between the drawing wires adjacent to each other is constituted of the same material as that of the polymer layer, the protrusion and the polymer layer can be formed in the same step. Accordingly, it is possible to enjoy a function as a protrusion, that is, an effect of preventing mis-positioning of the output lead conductors to the drawing wires, which is for securing the reliability of the electrical connection without any additional step.

As described above, in the liquid crystal display panel of the present invention, the protrusion can be formed in the same step of forming the polymer layer. In this case, the protrusion has substantially the same thickness as that of the polymer layer. Namely, a thickness of the protrusion can be set to 5 micrometers or less.

According to the method for manufacturing a liquid crystal display panel of the present invention, the polymer layer is formed on the insulating substrate once, and thereafter, the polymer layer on a specified area is removed by the same step. Thus, the through hole reaching the driving element is formed in the polymer layer, and the polymer layer existing on the drawing wires can be removed. In this case, though the polymer layer existing on the drawing wires is removed, the polymer layer between the drawing wires remains, and this remnant polymer layer forms the protrusion.

The liquid crystal display device of the present invention is a so-called PFA-type liquid crystal display device in which the displaying electrode is formed on the insulating layer. Accordingly, the problem of the short circuit between the displaying electrode and the signal line is solved. Moreover, in the liquid crystal display device of the present invention, since the protrusion provided between the drawing wires adjacent to each other is constituted of the same material as that of the insulating layer, the protrusion and the insulating layer can be formed in the same step. Accordingly, it is possible to enjoy a function as a protrusion, that is, an effect of preventing the mis-positioning of the output lead conductors to the drawing wires, which is for securing the reliability of the electrical connection without increasing the manufacturing cost.

In the liquid crystal display device of the present invention, conductive particles connecting the drawing wires and the output conductors, which are interposed between the drawing wires and the output conductors, can be provided. In this case, by the protrusion, the reliability of the electrical connection can be secured.

In order to sufficiently fulfill the function as a protrusion, in particular, the reliability of the electrical connection in the liquid crystal display device of the present invention, it is desirable that a thickness of the protrusion be set equal to a radius of each of the conductive particles or thicker. Moreover, the present invention can fulfill the function of preventing mis-positioning of the output lead conductors to the drawing wires and the function of securing the reliability of the electrical connection even in the high-resolution liquid crystal display device in which an interval between the drawing wires is 80 micrometers or less, further, 50 micrometers or less.

In the liquid crystal display device of the present invention, the sheet member can have a plurality of output conductors electrically connected to the drawing wires, and the connecting member can contain conductive particles electrically connecting the drawing wires and the output conductors to each other. In this case, the sheet member can include the plurality of output conductors electrically connected to the drawing wires, a tip portion of the dam can be disposed between the output conductors, in the event of a connecting process by the connecting member, the dam can prevent the conductive particles existing in the connecting member between the drawing wires and the output conductors from flowing out of a space between the drawing wires and the output conductors, and can prevent mis-positioning of the output conductors to the drawing wires due to thermal expansion of the sheet member.

Moreover, in the liquid crystal display device of the present invention, where a thickness of each of the output conductors is h2, and a radius of each of the conductive particles is d, it is desirable that a thickness hi of the dam be represented as: h1>h2+d for preventing from flowing out of the conductive particles.

Hereinbelow, description will be made for an embodiment of the present invention with reference to the drawings.

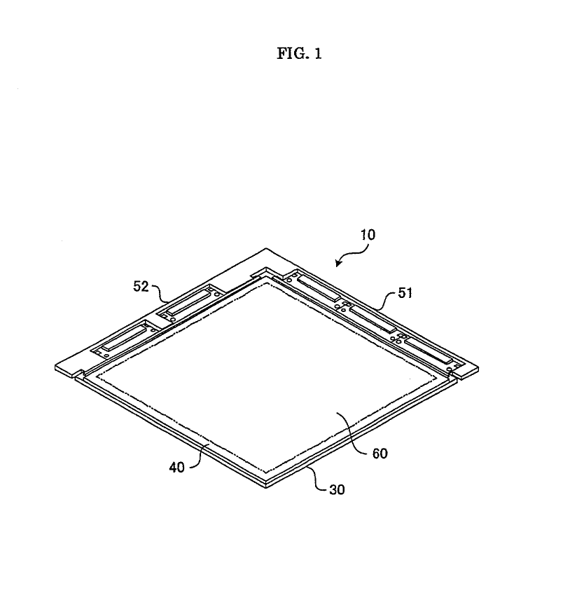

FIG. 1 is a perspective view showing a state where driving circuit portions 51 and 52 are mounted on a liquid crystal display panel 20 of a liquid crystal display device 10 according to this embodiment.

The liquid crystal display panel 20 is constructed in such a manner that an array substrate 30 as a first glass substrate and a color filter substrate 40 as a second glass substrate having a smaller surface area than the array substrate 30 are superposed. The array substrate 30 and the color filter substrate 40 are disposed so as to face each other with a specified gap interposed therebetween. And in the gap, the liquid crystal material is sealed. As described below in detail, various elements for driving the liquid crystal material are formed on the surfaces of the array substrate 30 and the color filter substrate 40, which face the gap. Along two sides of the array substrate 30, the driving circuit areas 51 and 52 for driving the liquid crystal material are formed.

Since an area of the array substrate 30 excluding the driving circuit areas 51 and 52 is nearly equal to an area of the color filter substrate 40, the driving circuit areas 51 and 52 are exposed to the outside when the array substrate 30 and the color filter substrate 40 are superposed. In these driving circuit areas 51 and 52, the printed circuit board is connected via the TAB tape carrier package to the liquid crystal display panel 20. Moreover, in the array substrate 30 and the color filter substrate 40, the region surrounded by a two-dot dashed line represents an image displaying area 60.

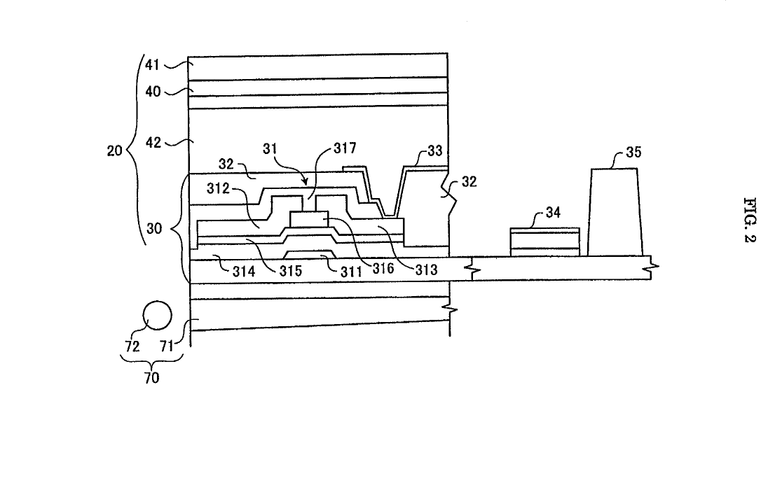

FIG. 2 shows a cross-section of the liquid crystal display device 10 according to this embodiment.

As shown in FIG. 2, when listed from the above in the drawing, the liquid crystal display device 10 comprises: the liquid crystal display panel 20 including a polarizing plate 41, the color filter substrate 40, a liquid crystal layer 42 filled with the liquid crystal material, the array substrate 30 having a TFT 31 formed on a glass substrate as an insulating substrate, a polymer layer 32 formed on the array substrate 30, and a displaying electrode 33 formed on the polymer layer 32 and conductively connected to the TFT 31 through the polymer layer 32; and a backlight unit 70 including a light guide plate 71 and a light source 72. This liquid crystal display device 10 is a PFA-type liquid crystal display device having the displaying electrode 33 on the polymer layer 32.

The construction of the TFT 31 is as follows. On the upper surface of the array substrate 30, a gate insulating film 314 is deposited. In this gate insulating film 314, a gate electrode 311 is formed, and on the gate insulating film 314, a semiconductor film 315 is deposited. On the semiconductor film 315 as a thin film transistor, source and drain electrodes 312 and 313 are formed. Between the source and drain electrodes 312 and 313, an etching protection film 316 is deposited. On the source and drain electrodes 312 and 313, a protection film 317 is deposited.

When a voltage is applied to the gate electrode 311, in a direction from the source electrode 312 to the drain electrode 313 or in a reverse direction, electrons pass through the semiconductor film 315 and thus current flows. When an OFF-state voltage is applied to the gate electrode 311, the source electrode 312 and the drain electrode 313 are cut off. Specifically, the gate electrode 311 has a function of turning on and off the TFT 31 as a switching element. In this case, a voltage is applied from the drain electrode 313 to the displaying electrode 33, and thus an electric field is generated between the displaying electrode 33 and a common electrode (not shown) formed on the color filter substrate 40. The liquid crystal material in the liquid crystal layer 42 is driven in response to this electric field.

Here, the gate electrode 311 and the source and drain electrodes 312 and 313 consist of a metal film such as Al, Ta, MoTa, MoW or the like. Moreover, the displaying electrode 33 consists of a transparent indium tin oxide (ITO) film.

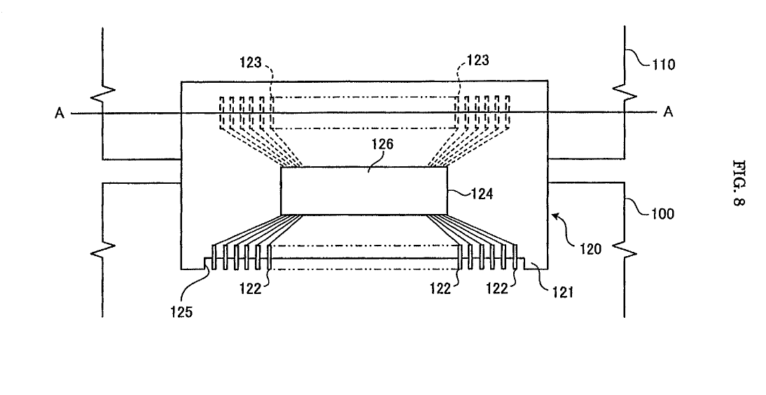

On a peripheral area of the array substrate 30 as the non-image displaying area, on which the driving circuit areas 51 and 52 are disposed, drawing wire 34 is formed to be electrically connected to the printed circuit board via the TAB tape carrier package. The drawing wire 34 in this embodiment has a three-layer structure as described later. The drawing wire 34 and the printed circuit board are connected to each other as described with reference to FIG. 8. Moreover, on the peripheral area of the array substrate 30, a dam 35 is formed adjacently to the drawing wire 34. This dam 35 is made of the same polymer material as that of the polymer layer 32. The liquid crystal display device 10 according to this embodiment is characterized in that the dam 35 as a protrusion thicker than this drawing wire 34 is disposed adjacently to the drawing wire 34. It should be noted that, although only the single drawing wire 34 and the single dam 35 are shown in FIG. 2 for the sake of space convenience, the dam 35 is actually formed for each drawing wire 34 adjacent thereto.

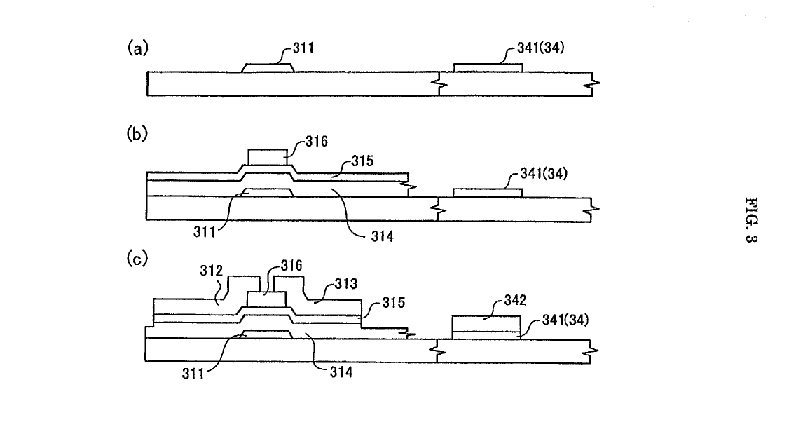

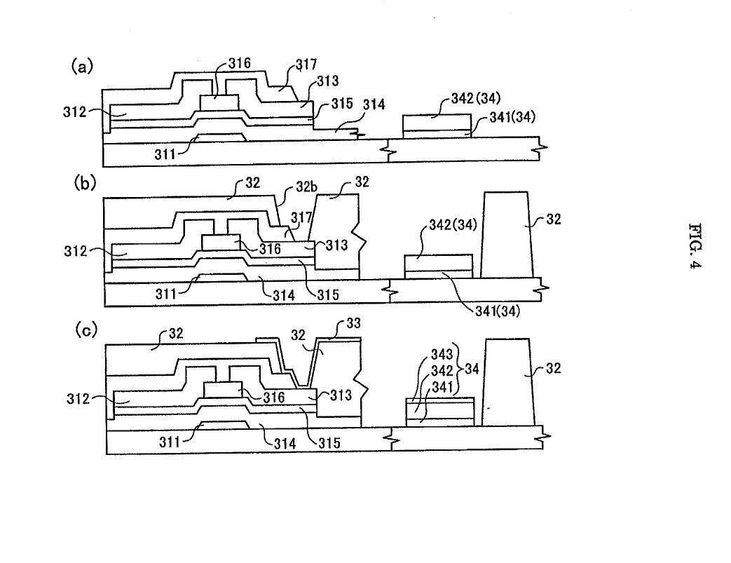

Next, description will be made for a manufacturing process of the array substrate 30 according to this embodiment with reference to FIGS. 3(a) to 3(c) and 4(a) to 4(c).

First, on the array substrate 30, a metal film for constituting the gate electrode 311 and the drawing wire 34 is deposited. Photo engraving process (PEP) is used to form the gate electrode 311 and the drawing wire 34. Specifically, on a glass substrate constituting the array substrate 30, the metal film constituting the gate electrode 311 and the drawing wire 34 is deposited by, for example, sputtering, and thereafter, the metal film is patterned by PEP as shown in FIG. 3(a). As the gate electrode 311, as described above, the metal film such as Ta, MoTa, MoW, Al or the like can be used.

Note that, other conductive materials are stacked on the drawing wire 34 later, thus constituting the drawing wire 34.

After forming the gate electrode 311 and the drawing wire 34, a film for constituting the gate insulating film 314 is deposited. As the gate insulating film 314, a silicon oxide (SiOx) film deposited by chemical vapour deposition (CVD) is typically used. A film for constituting the semiconductor film 315 is deposited on the film for constituting the gate insulating film 314 by CVD, for example. As the semiconductor film 315, an amorphous silicon (a-Si) film can be used. A film for constituting the etching protection film 316 is deposited on the film for constituting the semiconductor film 315 by CVD, for example. As the etching protection film 316, a silicon nitride (SiNx) film can be used. After depositing the film for constituting the etching protection film 316, patterning is performed by PEP as shown in FIG. 3(b) to deposit the gate insulating film 314, the semiconductor film 315 and the etching protection film 316.

Next, a metal film for forming the source and drain electrodes 312 and 313 is deposited by sputtering, for example. For this metal film, Ta, MoTa, MoW, Al or the like can be used. After depositing this metal film, patterning is performed by PEP as shown in FIG. 3(c) to form the source and drain electrodes 312 and 313. In this process, the metal film deposited on the drawing wire 34 is made to remain, and thus drawing wire 342 is formed.

Next, a film for constituting the protection film 317 for protecting the elements formed as before is deposited by CVD, for example, and thereafter, patterning is performed by PEP as shown in FIG. 4(a) to deposit the protection film 317. As the protection film 317, a silicon nitride (SiNx) film can be used.

Next, as shown in FIG. 4(b), the polymer layer 32 having a connection hole 32b penetrating to the drain electrode 313 is formed. This polymer layer 32 can be formed through the steps of coating a polymer solution, heating, curing and patterning by PEP. As the polymer constituting the polymer layer 32, for example, acrylic resin, epoxy resin and polyvinyl alcohol can be used. Moreover, a thickness of the polymer layer 32 is set to be 5 micrometers or less, preferably, 1 to 5 micrometers. The polymer layer 32 is an essential element for this liquid crystal display device 10 to constitute the PFA-type liquid crystal display device. However, this embodiment is characterized in that the polymer layer 32 is formed also between the drawing wires 34. Specifically, while the polymer layer 32 in the vicinity of the drawing wires 34 is removed by PEP performed after forming the polymer layer 32 in the conventional PFA-type liquid crystal display device, the polymer layer 32 between the drawing wires 34 is made to remain in this embodiment as found in FIG. 4(b).

Next, the ITO film for constituting the displaying electrode 33 is deposited on the polymer layer 32 by sputtering. After depositing the ITO film, patterning is performed by PEP as shown in FIG. 4(c) to form the displaying electrode 33. In this case, the ITO film deposited on the drawing wire 342 is made to remain. The remnant ITO film serves as drawing wire 343, and constitutes the drawing wire 34 together with the layers for drawing wires 341 and 342.

Thereafter, the color filter substrate 40 separately prepared is adhered onto the array substrate 30 via spacers and sealant (both are not shown). Thereafter, the liquid crystal material is filled into the gap between the array substrate 30 and the color filter substrate 40 to form the liquid crystal layer 42. After filling the liquid crystal material, the polarizing plate 41 is attached onto the color filter substrate 40. The liquid crystal display device 10 according to this embodiment shown in FIG. 2 can be obtained by disposing the liquid crystal display panel 20 completed as before over the backlight unit 70.

The liquid crystal display device 10 according to this embodiment is the PFA-type liquid crystal display device. Specifically, the displaying electrode 33 is formed on the polymer layer 32. Accordingly, as seen head-on, the gap between the displaying electrode 33 and the signal line does not have to be provided, thus enabling the aperture ratio of the liquid crystal display device 10 to be improved.

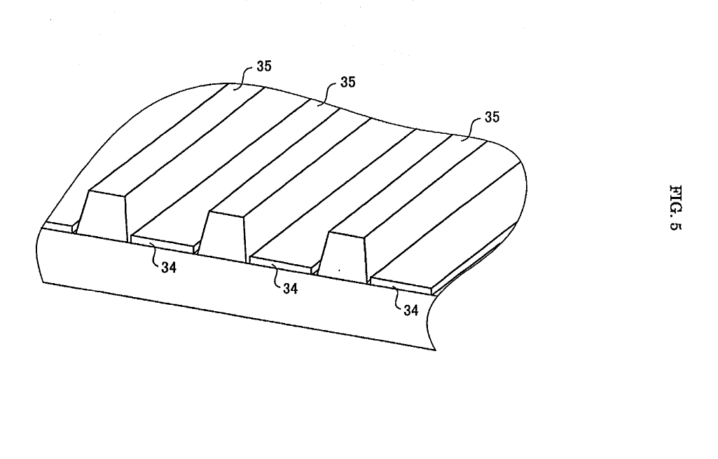

Moreover, the liquid crystal display device 10 according to this embodiment allows the polymer layer 32 to remain between the drawing wires 34. This polymer layer 32 having remained in a convex shape constitutes the dam 35. FIG. 5 is a partial perspective view showing the peripheral area of the array substrate 30, particularly showing the peripheral area for connecting the liquid crystal display device 10 to the printed circuit board. The conventional connection mode shown in FIG. 8 can be applied as it is to the connection in this embodiment of the liquid crystal display device 10 and the printed circuit board. Specifically, the drawing wires 34 are electrically connected to the output lead conductors 123 of the TAB tape carrier package 120 for connecting the liquid crystal display device 10 to the printed circuit board. As shown in FIG. 5, the dams 35 are disposed between these drawing wires 34. As described with reference to FIGS. 3 and 4, these dams 35 are formed at the same time when the polymer layer 32 for constituting the PFA-type liquid crystal display device is formed. That is, there is an advantage that the dams 35 can be formed without any additional step.

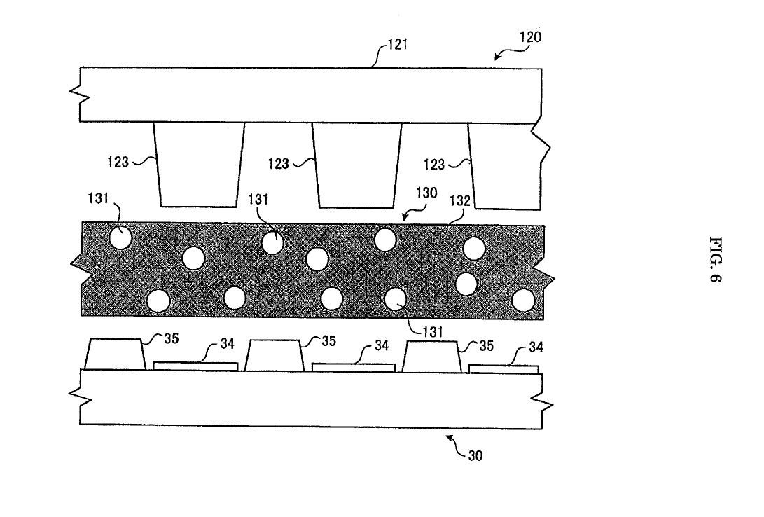

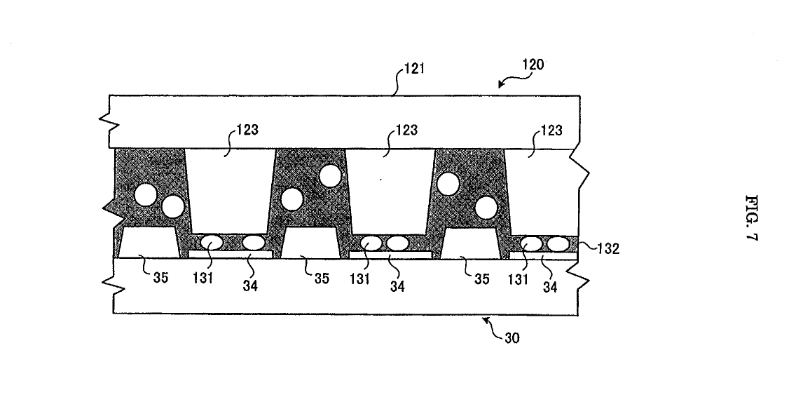

Description will be made for a connecting method of the liquid crystal display device 10 and the TAB tape carrier package 120 with reference to FIGS. 6 and 7. FIG. 6 shows a situation before the TAB tape carrier package 120 and the array substrate 30 are connected to each other, and FIG. 7 shows a situation after they are connected to each other. In FIG. 6, the TAB tape carrier package 120 and the array substrate 30 are made to face each other, and the output lead conductors 123 formed on the lower surface of the insulating film tape 121 and the drawing wires 34 formed on the array substrate 30 are made to face each other. In this case, the TAB tape carrier package 120 and the array substrate 30 are spaced with each other with a specified gap, and the ACF 130 is disposed therebetween. The ACF 130 is typically formed in such a manner that the conductive particles 131 are dispersed in the thermosetting resin 132 as a connecting member. As the conductive particles 131, fine powder of metal such as Ni and the one obtained by depositing a metal thin film surrounding fine powder made of resin can be used. In a state where the output lead conductors 123 and the drawing wires 34 are aligned to each other, the TAB tape carrier package 120 and the array substrate 30 are compressed and bonded to each other, and simultaneously, the ACF 130 is heated. Then, the thermosetting resin 132 is softened, and thereafter, is cured. The thermosetting resin 132 is softened and fluidized, and thus, as shown in FIG. 7, while the thermosetting resin 132 fills the gap between the TAB tape carrier package 120 and the array substrate 30, the conductive particles 131 remaining between the output lead conductors 123 and the drawing wires 34 realize the electrical connection between the output lead conductors 123 and the drawing wires 34.

According to this embodiment, the following effects are achieved by the dams 35 provided between the drawing wires.

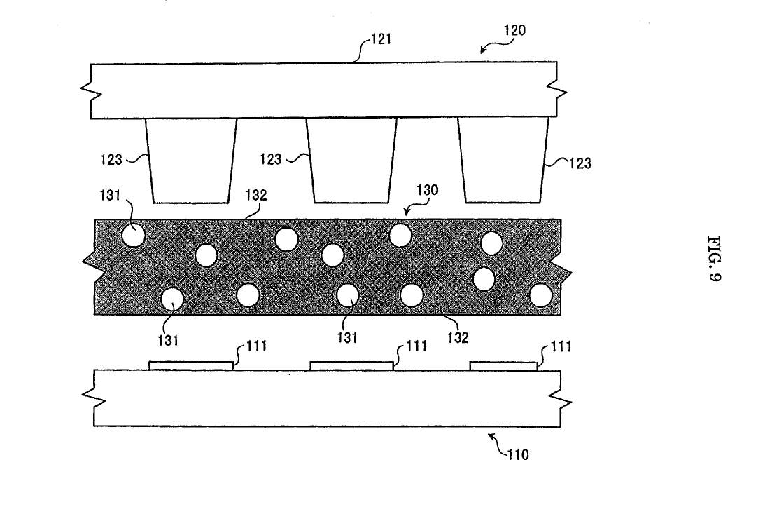

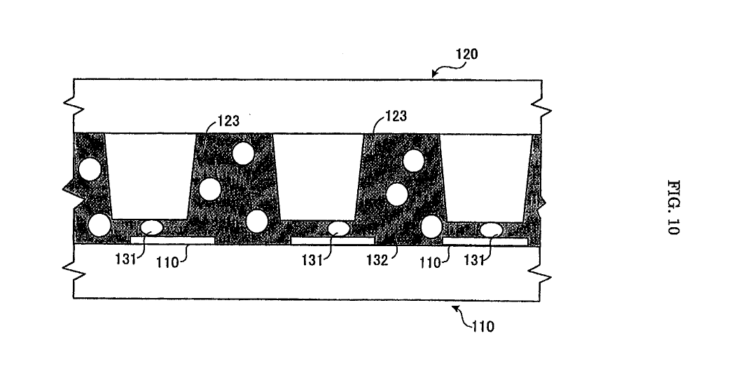

Firstly, the mis-positioning of the output lead conductors 123 to the drawing wires 34 due to thermal expansion of the TAB tape carrier package 120 can be suppressed. Specifically, even if the insulating film tape 121 constituting the TAB tape carrier package 120 is expanded by heating during the thermo-compression bonding of the ACF 130, the mis-positioning between the drawing wires 34 and the output lead conductors 123 can be minimized after the thermo-compression bonding since the motion of the output lead conductors 123 is restricted due to the presence of the dams 35. At least, the mis-positioning leading to the difficulty in the electrical connection between the drawing wires 34 and the output lead conductors 123, which correspond to each other, is not caused. Secondly, escape of the conductive particles 131 from the space between the output lead conductors 123 and the drawing wires 34 can be suppressed. Specifically, in the process of connecting the TAB tape carrier package 120 to the array substrate 30, particularly during the thermo-compression bonding of the ACF 130, the thermosetting resin 132 is softened and fluidized to be flowed out from the space between the output lead conductors 123 and the drawing wires 34. In this case, some of the conductive particles 131 are flowed out from the space between the output lead conductors 123 and the drawing wires 34. In the conventional array substrate 110 shown in FIGS. 9 and 10, there is nothing between the drawing wires 111, and thus the conductive particles 131 are easily flown out. On the contrary to this, in the liquid crystal display device 10 according to this embodiment, the dams 35 are formed between the drawing wires 34, and these dams 35 enter spaces between the output lead conductors 123. Thus, the flowing out of the conductive particles 131 from the space between the output lead conductors 123 and the drawing wires 34 can be suppressed.

As described above, the dams 35 play an important role for achieving two effects: one is the prevention of the mis-positioning of the output lead conductors 123 to the drawing wires 34; and the other is the prevention of the flowing out of the conductive particles 131. And, the liquid crystal display device 10 according to this embodiment is most characterized in that the PFA-type liquid crystal display device having the effects as described above can be manufactured without any additional step. Specifically, these two effects, which are the prevention of the mis-positioning of the output lead conductors 123 to the drawing wires 34 and the prevention of the flowing out of the conductive particles 131, are achieved without any additional step, while enjoying the benefit of the PFA-type liquid crystal display device capable of increasing the aperture ratio, thus leading to an advantage for the high resolution of the liquid crystal display device 10.

The dams 35 according to this embodiment are desirably provided with the following conditions in order to obtain the above-described effects. Firstly, with regard to the dimension, the minimum condition is that each of the dams 35 is thicker than the drawing wire 34. If the dams 35 is thinner than the drawing wire 34, it is difficult to obtain the two effects which are the prevention of the mis-positioning of the output lead conductors 123 to the drawing wires 34 and the prevention of the flowing out of the conductive particles 131. Moreover, with regard to the relation between the dams 35 and the conductive particles 131 in size, each of the dams 35 desirably has a thickness equal to a radius of the conductive particle 131 or more. If the dam 35 is thinner relative to the conductive particle 131, there is an increased possibility that the conductive particle 131 runs up onto the dam 35 in the process of thermo-compression bonding of the ACF 130, and thus it may be incapability of sufficiently enjoying the restriction effects for the escape of the conductive particles 131. Furthermore, with regard to the relation of the dams 35 with the output lead conductors 123 and the conductive particles 131, the following condition is desirable. Specifically, where the thickness of each of the output lead conductors 123 is h2, and the radius of each of the conductive particles 131 is d, the thickness hi of each of the dams 35 is represented as: h1>h2+d in order to enjoy the effects by the dams 35 sufficiently. However, it is not desirable that the thickness of the dam 35 be made larger than necessary. The thickness should be set to 5 micrometers or less, desirably 1 to 5 micrometers. The thickness of the dam 35 has been described as above. The width of each of the dams 35 depends almost on the pitch of the drawing wires 34. The pitch of the drawing wires 34 depends on the resolution of the liquid crystal display device 10. Specifically, the higher the resolution of the liquid crystal display device 10 is, the more the number of the drawing wires 34 is increased. In accordance with the increase in number, the width and pitch of the drawing wires 34 are narrowed. Recently, the pitch of the drawing wires 34 has been extremely minimized to 80 micrometers or less, or further, to some 50 micrometers or less. In this case, the width of the dam 35 is set to be a value below 80 micrometers, or even below 50 micrometers.

Here, according to the examination of the inventor, with regard to the distribution of the conductive particles 131 during the connection by the use of the ACF 130, the followings have been found out under the conditions where the pressure and temperature during the connection are fixed. It should be noted that a capture ratio mentioned herein is referred to as a ratio of the conductive particles 131 remaining in the space between the drawing wires 34 and the output lead conductors 123 after they are heated and cured to the number of the conductive particles 131 to be present between the drawing wires 34 and the lead conductors 123 on the assumption that the conductive particles 131 do not flow out.

The distribution of the conductive particles 131 has a correlation with the density thereof in the ACF 130 for use in the connection.

The distribution takes a generally binomial distribution in any particle diameter.

When the area of the drawing wire 34 is reduced, that is, when the pitch is shortened, the capture ratio of the conductive particles 131 does not take a linear proportional relation.

Based on viscosity of resin as a binder constituting the ACF 130, both the capture ratio and the distribution are changed.

The size of the conductive particles 131 has little to do with the reliability of the electrical connection and the size of the total connection area of the captured conductive particles 131 affects the reliability of the electrical connection.

The inventor actually measured the capture ratio. When the pitch of the drawing wires 34 was 120 micrometers, the capture ratio was 40%. When the pitch was 75 micrometers, it was 30%. And when the pitch was 64 micrometers, it was 13%. The capture ratio is reduced as described above. As the pitch is narrowed, the capture ratio does not show a linear proportion but a nearly quadratic curve to the pitch. However, the present inventor confirmed that, by providing the dams 35 as in this embodiment, the capture ratio of the same level as in the case where the pitch was about 120 micrometers could be secured even in the case where the pitch was narrowed to 80 micrometers, or further, to some 50 micrometers. Therefore, according to this embodiment, it is suggested to be possible to secure the electrical connection between the drawing wires 34 and the output lead conductors 123 of the TAB tape carrier package 120 even in the liquid crystal display device 10 where the pitch is narrowed, in other words, even in the liquid crystal display device 10 having the enhanced resolution. Moreover, the reliability of the electrical connection can be enhanced by obtaining the capture ratio proportional to the density of the conductive particles 131 of the ACF 130 even if the pitch of the drawing wires 34 is changed.

The following effects can be also achieved by forming the dams 35 in the same process as that for the polymer layer 32. Specifically, according to this embodiment, since the polymer layer 32 exists to the peripheral area of the array substrate 30, the evenness inside the surface of the cell gap, which is formed when the color filter substrate 40 is superposed onto the array substrate 30, is improved, in comparison with the conventional liquid crystal display panel in which the polymer layer 32 in the peripheral area has been removed. This results in contribution to the improvement of image quality. Moreover, when the polymer layer 32 is patterned, the polymer layer 32 subject to etching exists evenly in the image displaying area and peripheral area of the array substrate 30. Therefore, a difference in the etching rate, which depends on the area, is lowered. Accordingly, it shows an effect that the incidence of pattern defects represented by side etching is lowered.

The liquid crystal display device 10 described above is an embodiment of the present invention, and does not constitute a base for limiting the present invention. For example, the present invention can be also applied to a known back channel etch-type TFT or a top gate-type TFT as a structure of the TFT. Moreover, although the ACF 130 including the conductive particles 131 is used, the electrical connection between the drawing wires 34 and the output lead conductors 123 can be also obtained by directly contacting the both. Specifically, resin which does not include the conductive particles 131 can be used as a connecting member. In this case, the reliability of the electrical connection between the output lead conductors 123 and the drawing wires 34 can be secured by the effect of preventing mis-positioning of the output lead conductors 123 to the drawing wires 34, the effect being brought about by the dams 35. Furthermore, with regard to the materials constituting the respective constituent components including the gate electrode 311, the source and drain electrodes 312 and 313 and the like, other materials than the ones exemplified above can be used.

And, with regard to the process of manufacturing the array substrate 30, other processes more simplified than the one shown in FIG. 3 can be also adopted.

As described above, according to the present invention, the mis-positioning between the drawing wires and the output lead conductors can be effectively prevented, and the reliability of the electrical connection of the both can be secured.

Moreover, in the case where the ACF is used for the connection, the capture ratio of the conductive particles is increased, and the reliability of the electrical connection thereof can be secured.

In the above, description has been made on the assumption that the present invention will be applied to the liquid crystal display device. However, an application object of the present invention is not limited to the liquid crystal display device, and the present invention can be widely applied to the purpose of jointing the wires to each other via the conductive particles.

Although the preferred embodiment of the present invention has been described in detail, it should be understood that various changes, substitutions and alternations can be made therein without departing from spirit and scope of the inventions as defined by the appended claims.

1. A liquid crystal display panel comprising:
an array substrate having a driving element for a liquid crystal material formed thereon;
a color filter substrate disposed facing to said array substrate with a specified gap therebetween; and
a liquid crystal layer located in the gap between said array substrate and said color filter substrate,
wherein said array substrate includes:
an insulating substrate having an image displaying area and a non-image displaying area;
the driving element for the liquid crystal material formed on said image displaying area on said insulating substrate;
a polymer layer for covering said image displaying area including said driving element;
a displaying electrode formed on said polymer layer and electrically connected to said driving element through said polymer layer;
a plurality of drawing wires formed on said non-image displaying area of said insulating substrate for electrically connecting to an exterior; and
a protrusion provided between said drawing wires adjacent to each other, the protrusion made of the same material as that of said polymer layer.

2. The liquid crystal display panel according to claim 1, wherein said protrusion has substantially the same thickness as that of said polymer layer.

3. The liquid crystal display panel according to claim 1, wherein a thickness of said protrusion is 5 micrometers or less.

4. A method of manufacturing a liquid crystal display panel, said method comprising the steps of:
(a) forming a driving element for a liquid crystal material and a plurality of drawing wires for electrically connecting to an exterior on an insulating substrate;
(b) forming a polymer layer on said insulating substrate including said driving element and said drawing wires;
(c) forming a through hole reaching said driving element in said polymer layer and removing said polymer layer existing on said drawing wires; and
(d) forming a displaying electrode penetrating said through hole formed in said step (c) to be electrically connected to said driving element.

5. A liquid crystal display device in which a displaying electrode formed on an insulating layer and an array substrate including a plurality of drawing wires for electrically connecting to an exterior are provided, said liquid crystal display device comprising:
a liquid crystal display panel including an array substrate having a protrusion made of the same material as that of said insulating layer provided between said drawing wires adjacent to each other, a color filter substrate disposed facing to said array substrate, and a liquid crystal layer disposed between said array substrate and said color filter substrate, the liquid crystal layer consisting of a liquid crystal material;
a circuit board for supplying a driving voltage to said liquid crystal material; and
a sheet member for electrically connecting said circuit board and said liquid crystal display panel to each other, the sheet member having output conductors corresponding to said drawing wires.

6. The liquid crystal display device according to claim 5, further comprising conductive particles for electrically connecting said drawing wires and said output conductors to each other, the conductive particles being interposed between said drawing wires and said output conductors.

7. The liquid crystal display device according to claim 6, wherein said protrusion has a thickness equal to a radius of said conductive particles or larger.

8. The liquid crystal display device according to claim 6, wherein an interval between said drawing wires is 80 micrometers or less.

9. A liquid crystal display device comprising:
a liquid crystal display panel including a displaying electrode for applying a voltage to a liquid crystal material and a glass substrate having a plurality of drawing wires formed thereon for electrically connecting between said displaying electrode and an exterior;
a circuit board for supplying said voltage to the liquid crystal material; and
a sheet member for electrically connecting said glass substrate and said circuit board to each other, the sheet member being connected to said glass substrate with a connecting member,
wherein said glass substrate of said liquid crystal display panel has said displaying electrode provided on a polymer layer formed in an image displaying area and has a dam made of the same material as that of said polymer layer between said drawing wires adjacent to each other outside said image displaying area.

10. The liquid crystal display device according to claim 9, wherein said sheet member has a plurality of output conductors electrically connected to said drawing wires, and
said connecting member contains conductive particles electrically connecting
said drawing wires and said output conductors to each other.

11. The liquid crystal display device according to claim 10, wherein a tip portion of said dam is disposed between said output conductors, and
in the event of a connecting process by said connecting member, said dam prevents the conductive particles existing between said drawing wires and said output conductors in said connecting member from flowing out of a space between said drawing wires and said output conductors, and prevents mis-positioning of said output conductors to said drawing wires due to thermal expansion of said sheet member.

12. The liquid crystal display device according to claim 10,
wherein, where a thickness of said output conductors is h2, and a radius of said conductive particles is d, a thickness h1 of said dam is represented as: h1>h2+d.

13. A method of manufacturing a liquid crystal display device, in which a liquid crystal display panel and a circuit board for driving said liquid crystal display panel are connected to each other via a tape carrier package, the liquid crystal display panel including a first insulating layer forming a displaying electrode on a surface thereof and a plurality of drawing wires electrically connecting to an exterior, said method comprising the steps of:
forming said first insulating layer and forming a second insulating layer between said drawing wires adjacent to each other in a process of obtaining said liquid crystal display panel; and
connecting said tape carrier package and said liquid crystal display panel via a connecting member.

14. A connected body of substrates comprising:
a first substrate including a plurality of first wires formed with a specified space therebetween, a first polymer layer formed between said first wires adjacent to each other, the first polymer layer having a thickness larger than said first wire, and a second polymer layer covering an area different from an area having said first wire and said first polymer layer formed thereon, the second polymer layer being formed of the same material as that of said first polymer layer;
a second substrate including a plurality of second wires electrically connected to said first wires; and
a connecting member layer mechanically connecting said first substrate and said second substrate.
